(19) United States
(12) Patent Application Publication
(10) Pub. No.: US 2026/0144177 A1
(43) Pub. Date: May 28, 2026

(54) FOOT PLATE OR KICK PLATE THAT IS REVERSIBLY ATTACHABLE TO A SHOVEL

(71) Applicants: Harlan J. Wilson, SR., Escalon, CA (US); Travis J. Wilson, Escalon, CA (US)

(72) Inventors: Harlan J. Wilson, SR., Escalon, CA (US); Travis J. Wilson, Escalon, CA (US)

(21) Appl. No.: 18/958,387

(22) Filed: Nov. 25, 2024

(51) Int. Cl. A01B 1/02

(52) U.S. Cl. CPC A01B 1/02

(57) ABSTRACT

Foot plate or a kick plate is reversibly attachable to a shovel wherein the foot plate or kick plate allows for the shovel user to press much more firmly downward or kick very firmly downward on the blade of the shovel thereby exponentially increasing the amount of downward pressure applied to the shovel blade, as compared to not having the foot plate or kick plate, in order to more easily penetrate and dig into hard ground. Foot plate or a kick plate has a pressure plate, a backer plate, and a plurality of fasteners. Foot plate or a kick plate pierces the surface of the collar or socket of shovel blade when attached thereto.

### BACKGROUND OF THE INVENTION

### 1. Field of the Invention

This invention relates to a foot plate or a kick plate that is reversibly attachable to a shovel wherein the foot plate or kick plate allows for the shovel user to press much more firmly downward or kick very firmly downward on the blade of the shovel thereby exponentially increasing the amount of downward pressure applied to the shovel blade, as compared to not having the foot plate or kick plate, in order to more easily penetrate into hard ground and more easily dig into hard ground.

### 2. Description of Related Art

There are other shovel foot plates or shovel kick plates in the prior art however none have structure as described below. Specifically, this shovel foot plate or shovel kick plate has a pressure plate and a backer plate that attach to the shovel by impaling or penetrating the surface of the shovel in order to more rigidly attach to the shovel. Additionally, this shovel foot plate or shovel kick plate includes special stiffening structure that make the pressure plate and the backer plate exceptionally strong and rigid. These aspects are not present in the prior art.

### BRIEF SUMMARY OF THE INVENTION

It is an aspect of foot plate or kick plate that is reversibly attachable to a shovel to be reversibly attachable to a shovel.

It is an aspect of foot plate or kick plate that is reversibly attachable to a shovel to include a pressure plate that is a rigid horizontal member.

It is an aspect of the pressure plate to include strength beads and/or support structure underneath.

It is an aspect of foot plate or kick plate that is reversibly attachable to a shovel to include a backer plate that is a rigid vertical member that is attached to the pressure plate.

It is an aspect of pressure plate and backer plate to sandwich and clamp onto a shovel blade when attached to a shovel.

It is an aspect of foot plate or kick plate that is reversibly attachable to a shovel to pierce or embed into the surface of a shovel blade when attached to a shovel.

### BRIEF DESCRIPTION OF THE DRAWINGS

FIG. 1 is a perspective view of foot plate or kick plate that is reversibly attachable to a shovel attached to a shovel and being used by a person.

FIG. 2 is a perspective view of an embodiment of foot plate or kick plate that is reversibly attachable to a shovel attached to a shovel.

FIG. 3 is a perspective view of another embodiment of foot plate or kick plate that is reversibly attachable to a shovel attached to a shovel.

FIG. 4 is an enlarged upper perspective view of the fifth embodiment of foot plate or kick plate that is reversibly attachable to a shovel.

FIG. 5 is an enlarged lower perspective view of the fifth embodiment of foot plate or kick plate that is reversibly attachable to a shovel.

FIG. 6 is an assembly view the fifth embodiment of foot plate or kick plate that is reversibly attachable to a shovel.

FIG. 7 is an enlarged upper perspective view of the fourth embodiment of foot plate or kick plate that is reversibly attachable to a shovel.

FIG. 8 is an enlarged lower perspective view of the fourth embodiment of foot plate or kick plate that is reversibly attachable to a shovel.

FIG. 9 is an assembly view the fourth embodiment of foot plate or kick plate that is reversibly attachable to a shovel.

### DEFINITION LIST

| Term | Definition |
|---|---|
| 5 | Foot Plate or Kick Plate that is |
| | Reversibly Attachable to a Shovel |
| 10 | Pressure Plate |
| 12 | Shovel Slot |
| 14 | Upper Mounting Flange |
| 16 | Lower Mounting Flange |
| 18 | Pressure Plate Mounting Hole |
| 20 | Pressure Plate Left Edge Flange |
| 22 | Pressure Plate Right Edge Flange |
| 24 | Pressure Plate Rear Edge Flange |
| 25 | Pressure Plate Left Rear Edge Flange |
| 26 | Pressure Plate Right Rear Flange |
| 28 | Pressure Plate Bead |
| 32 | First Pressure Plate Keyhole |
| 34 | Second Pressure Plate Keyhole |
| 36 | Third Pressure Plate Keyhole |
| 38 | Fourth Pressure Plate Keyhole |
| 40 | Backer Plate |
| 42 | Backer Plate Mounting Hole |
| 44 | Backer Plate Keyhole |
| 50 | Fastener |
| 60 | Saddle Bracket |
| 62 | Saddle Bracket Keyhole |
| 70 | Saddle Bracket Alignment Plate |
| 72 | Saddle Bracket Alignment Plate Key |
| 80 | Center Support Member |
| 82 | First Center Support Member Key |
| 84 | Second Center Support Member Key |
| 86 | Third Center Support Member Key |
| 88 | Fourth Center Support Member Key |
| 90 | Outer Support Member |
| 92 | First Outer Support Member Key |
| 94 | Second Outer Support Member Key |
| 96 | Outer Support Member Keyhole |
| 100 | Shovel |
| 102 | Shovel Handle |
| 104 | Shovel Blade |
| 106 | Blade Portion |
| 108 | Collar or Socket |
| 110 | Person |
| 112 | Person's Foot |

### DETAILED DESCRIPTION OF THE INVENTION

Foot plate or kick plate that is reversibly attachable to a shovel 5 is reversibly rigidly attachable to a shovel 100. A shovel 100 is a tool used for digging, lifting, and moving bulk materials, such as soil, coal, gravel, snow, sand, or ore. Shovels 100 are hand tools consisting of a shovel blade affixed to a shovel handle. Shovel handles 102 are usually made of wood or fiberglass. A shovel handle 102 is a rigid cylindrical member or oblong member with a length, an outer diameter, and a longitudinal axis. Shovel blades 104 are usually made of sheet steel and are very strong. Shovels blades 104 have a blade portion 106 portion and a collar or socket 108. The blade portion 106 is a rigid wide scooped shaped member that digs into the ground and scoops out portions of the ground. The collar or socket 108 is a rigid hollow cylindrical member with a first end and a second end. The collar or socket 108 is rolled or forged into a rigid hollow cylindrical member. The first end of collar or socket 108 is integral with the blade portion 106 and made of the same piece of material. The second end of collar or socket 108 is open and functions to receive the lower end of the shovel handle 102. The lower end of shovel handle 102 is inserted into the second end of collar or socket 108 and rigidly attached to collar or socket 108. A shovel 100 is not a part of this invention. Foot plate or kick plate that is reversibly attachable to a shovel 5 is typically purchased separately from a shovel 100 and then mounted to a shovel 100.

In a first embodiment, foot plate or kick plate that is reversibly attachable to a shovel 5 comprises: a pressure plate 10; a backer plate 40; and a plurality of fasteners 50.

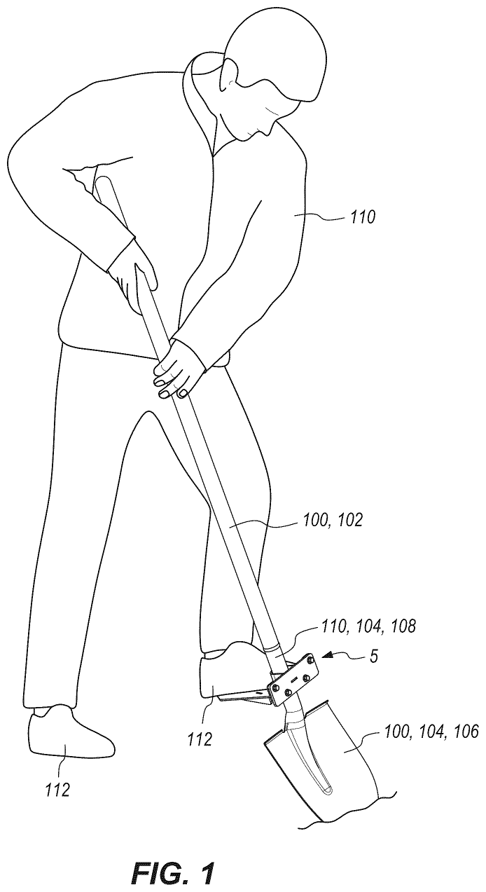

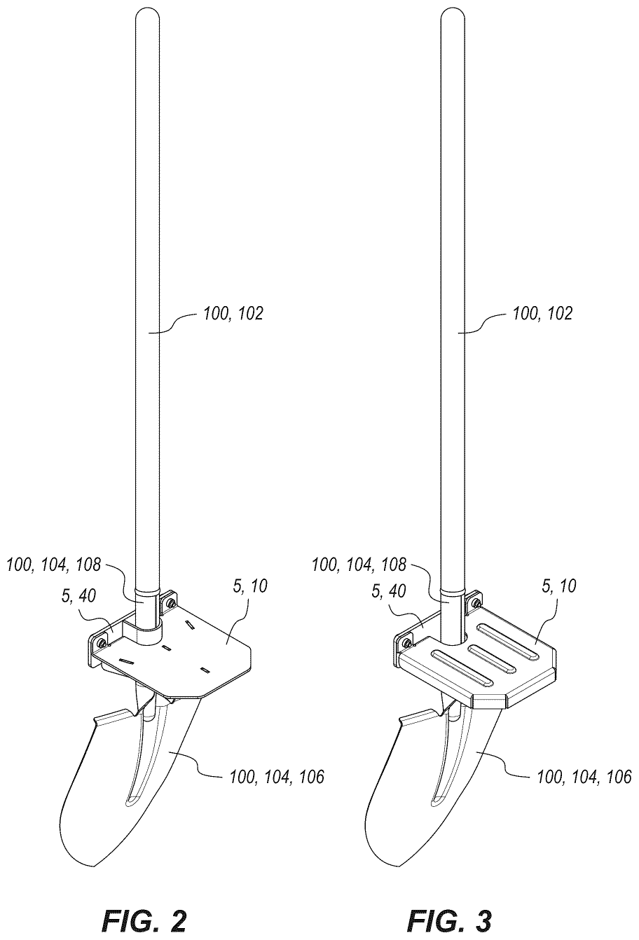

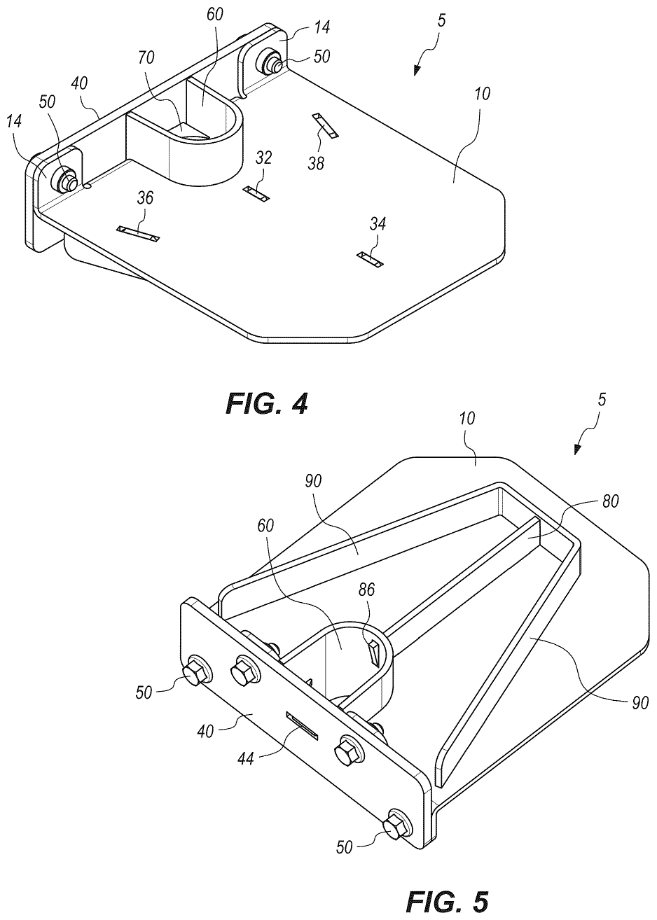

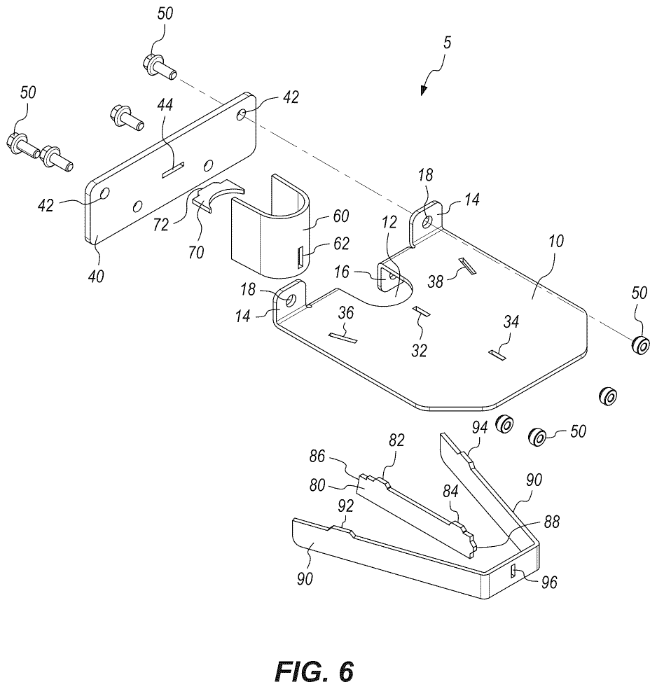

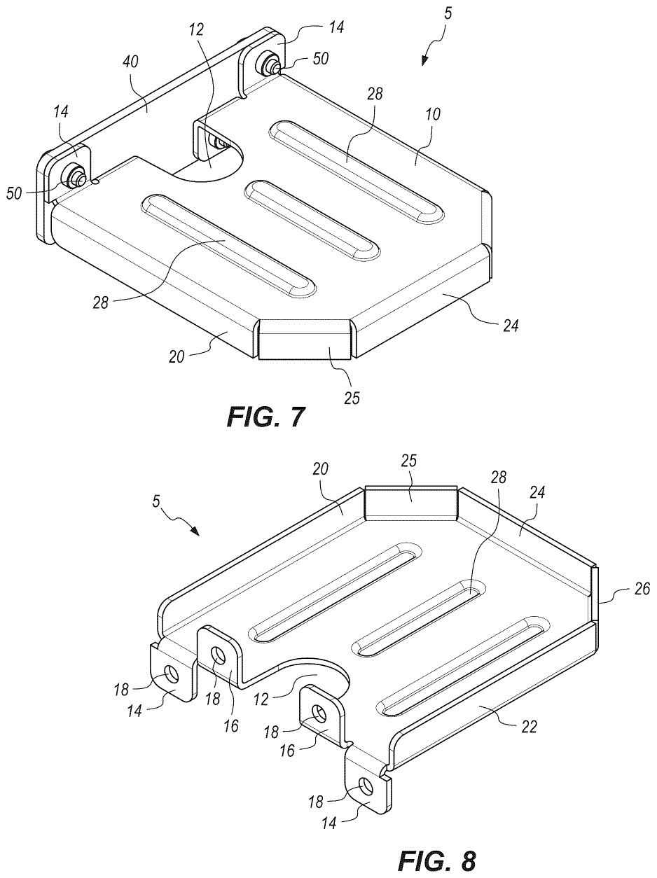

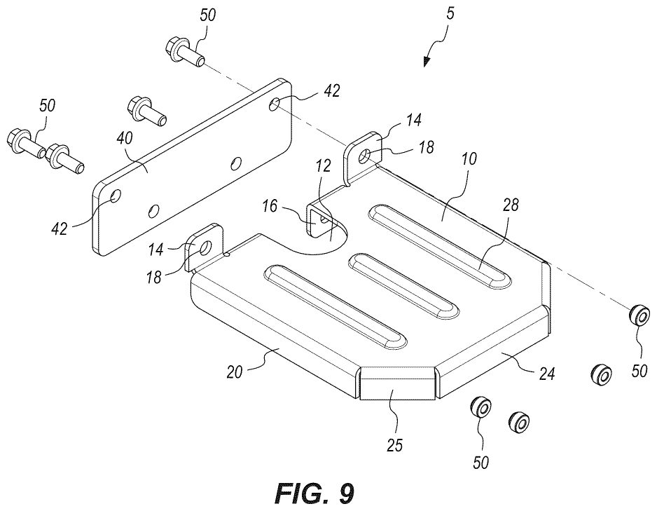

In all embodiments, pressure plate 10 is a rigid horizontal planar member with a front edge, a rear edge, a left edge, a right edge, an upper surface, a lower surface, a thickness, a width, a length, and a plane. Pressure plate 10 is the main component of foot plate or kick plate that is reversibly attachable to a shovel 5. Throughout this writing, the perspective of the shovel user or person 110 using the shovel 100 is applied. This means that front, rear, left, and right coincide with the front, rear, left, and right sides respectively of the person 110 using the shovel 100 as depicted in FIG. 1. Pressure plate 10 has a width of about 2-10 inches, a length of about 4-20 inches, and a thickness of about 0.1-1.0 inches. Pressure plate 10 is rigidly mounted or rigidly attached to a shovel 100 so that the plane of pressure plate 10 is perpendicular to the longitudinal axis of the shovel handle 102, as described below. Pressure plate 10 may be made of any known material such as: metal, steel, aluminum, polymer, plastic, composite, wood, fiberglass, ceramic, carbon fiber, or any other known material. In best mode, pressure plate 10 is made of hardened steel. As stated below, the pressure plate 10 must be hard enough to pierce the surface of the collar or socket 108 of shovel blade 104.

In all embodiments, pressure plate 10 has a shovel slot 12 at its front edge. Shovel slot 12 is an aperture, slit, opening, or, notch in pressure plate 10 at the front edge of pressure plate 10. Shovel slot 12 has a width, a length, a front end, a rear end, and a longitudinal axis. The width of shovel slot 12 is slightly larger than the width of a shovel handle 102. The longitudinal axis of shovel slot 12 is perpendicular to the front edge of pressure plate 10. Shovel slot 12 “breaks through” the front edge of pressure plate 10 and thus the rear end of shovel slot 12 is open. The front end of shovel slot 12 is radiused or rounded to match the radius or outer diameter of a shovel handle 102. Shovel slot 12 functions as clearance space for the shovel blade 104 or shovel handle 102 when foot plate or kick plate that is reversibly attachable to a shovel 5 is properly attached to a shovel 100.

In all embodiments, pressure plate 10 has a set of two upper mounting flanges 14 and a set of two lower mounting flanges 16 at the front edge of pressure plate 10.

Each upper mounting flange 14 is a protruded ridge, lip, rim, or flange in the common definition of the word. Each upper mounting flange 14 is a rigid planar member with an upper edge, a lower edge, a left edge, a right edge, a front surface, a rear surface, a width, a length, a thickness, and a plane. The lower edge of each upper mounting flange 14 is contiguous with and rigidly attached to the front edge of pressure plate 10. The plane of each upper mounting flange 14 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, each upper mounting flange 14 is integral with pressure plate 10 that was brake bent or stamped from the same sheet of material. There is a pressure plate mounting hole 18 on each upper mounting flange 14. Each pressure plate mounting hole 18 is a circular hole through the upper mounting flange 14. Each pressure plate mounting hole 18 has a longitudinal axis that is perpendicular to the plane of upper mounting flange 14. Each pressure plate mounting hole 18 has an inner diameter that is sized to make a clearance fit with the outer diameter of fastener 50. Each upper mounting flange 14 functions as a fastener attachment area that is used to rigidly attach pressure plate 10 to backer plate 40 with a fastener 50.

Each lower mounting flange 16 is a protruded ridge, lip, rim, or flange in the common definition of the word. Each lower mounting flange 16 is a rigid planar member with an upper edge, a lower edge, a left edge, a right edge, a front surface, a rear surface, a width, a length, a thickness, and a plane. The upper edge of each lower mounting flange 16 is contiguous with and rigidly attached to the front edge of pressure plate 10. The plane of each lower mounting flange 16 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, each lower mounting flange 16 is integral with pressure plate 10 that was brake bent or stamped from the same sheet of material. There is a pressure plate mounting hole 18 on each lower mounting flange 16. Each pressure plate mounting hole 18 is a circular hole through the lower mounting flange 16. Each pressure plate mounting hole 18 has a longitudinal axis that is perpendicular to the plane of lower mounting flange 16. Each pressure plate mounting hole 18 has an inner diameter that is sized to make a clearance fit with the outer diameter of fastener 50. Each lower mounting flange 16 functions as a fastener attachment area that is used to rigidly attach pressure plate 10 to backer plate 40 with a fastener 50.

In a second embodiment of foot plate or kick plate that is reversibly attachable to a shovel 5, pressure plate 10 further comprises: one or more pressure plate beads 28. Each pressure plate bead 28 is a groove, channel, trough, or depression in the pressure plate 10. Each pressure plate bead 28 is rolled, pressed, or formed into the plane of the pressure plate 10. Each pressure plate bead 28 is a bead according to the standard definition of a bead in a sheet of material to add strength and decoration. Each pressure plate bead 28 adds strength and rigidity to the pressure plate 10.

In a third embodiment of foot plate or kick plate that is reversibly attachable to a shovel 5, pressure plate 10 further comprises: a pressure plate left edge flange 20, a pressure plate right edge flange 22, and a pressure plate rear edge flange 24.

Pressure plate left edge flange 20 is a protruded ridge, lip, rim, or flange in the common definition of the word. Pressure plate left edge flange 20 is a rigid planar member with an upper edge, a lower edge, a front edge, a rear edge, a left surface, a right surface, a width, a length, a thickness, and a plane. The upper edge of pressure plate left edge flange 20 is contiguous with and rigidly attached to the left edge of pressure plate 10. The plane of pressure plate left edge flange 20 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, pressure plate left edge flange 20 is integral with pressure plate 10 that was brake bent or stamped from the same sheet of material. Pressure plate left edge flange 20 functions by increasing strength and rigidity to pressure plate 10.

Pressure plate right edge flange 22 is a protruded ridge, lip, rim, or flange in the common definition of the word. Pressure plate right edge flange 20 is a rigid planar member with an upper edge, a lower edge, a front edge, a rear edge, a left surface, a right surface, a width, a length, a thickness, and a plane. The upper edge of pressure plate right edge flange 22 is contiguous with and rigidly attached to the right edge of pressure plate 10. The plane of pressure plate right edge flange 22 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, pressure plate right edge flange 22 is integral with pressure plate 10 that was brake bent or stamped from the same sheet of material. Pressure plate right edge flange 22 functions by increasing strength and rigidity to pressure plate 10.

Pressure plate rear edge flange 24 is a protruded ridge, lip, rim, or flange in the common definition of the word. Pressure plate rear edge flange 24 is a rigid planar member with an upper edge, a lower edge, a front edge, a rear edge, a left surface, a right surface, a width, a length, a thickness, and a plane. The upper edge of pressure plate rear edge flange 24 is contiguous with and rigidly attached to the rear edge of pressure plate 10. The plane of pressure plate rear edge flange 24 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, pressure plate rear edge flange 24 is integral with pressure plate 10 that was brake bent or stamped from the same sheet of material. Pressure plate rear edge flange 24 functions by increasing strength and rigidity to pressure plate 10. The addition of pressure plate left edge flange 20, pressure plate right edge flange 22, and pressure plate rear edge flange 24 exponentially increases the rigidly of pressure plate 10.

In a fourth embodiment of foot plate or kick plate that is reversibly attachable to a shovel 5, pressure plate 10 further comprises: a pressure plate left rear edge flange 25 and a pressure plate right rear edge flange 26. In this embodiment, there is an additional edge on the pressure plate 10 in between the left edge and the rear edge, that is a diagonal edge that meets the left edge and the rear edge at a 45-degree angle. This additional edge is called the left rear edge. Also in this embodiment, there is an additional edge on the pressure plate 10 in between the right edge and the rear edge, that is a diagonal edge that meets the right edge and the rear edge at a 45-degree angle. This additional edge is called the right rear edge.

Pressure plate left rear edge flange 25 is a protruded ridge, lip, rim, or flange in the common definition of the word. Pressure plate left rear edge flange 25 is a rigid planar member with an upper edge, a lower edge, a front edge, a rear edge, a left surface, a right surface, a width, a length, a thickness, and a plane. The upper edge of pressure plate left rear edge flange 25 is contiguous with and rigidly attached to the left rear edge of pressure plate 10. The plane of pressure plate left rear edge flange 25 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, pressure plate left rear edge flange 25 is integral with pressure plate 10 that was brake bent or stamped from the same sheet of material. Pressure plate left rear edge flange 25 functions by increasing strength and rigidity to pressure plate 10.

Pressure plate right rear edge flange 26 is a protruded ridge, lip, rim, or flange in the common definition of the word. Pressure plate right rear edge flange 26 is a rigid planar member with an upper edge, a lower edge, a front edge, a rear edge, a left surface, a right surface, a width, a length, a thickness, and a plane. The upper edge of pressure plate right rear edge flange 26 is contiguous with and rigidly attached to the right rear edge of pressure plate 10. The plane of pressure plate right rear edge flange 26 is perpendicular to that of pressure plate 10. Rigid attachment may be accomplished by any known means such as: brake bending, stamping, pressed seam, weld, solder, glue, epoxy, adhesive, bolts, screws, rivets, clips, snaps, pins, or fasteners. In best mode, pressure plate right rear edge flange 26 is integral with pressure plate 10 that was brake bent or stamped from the same sheet of material. Pressure plate right rear edge flange 26 functions by increasing strength and rigidity to pressure plate 10. The addition of pressure plate left rear edge flange 25 and pressure plate right rear flange 26 exponentially increases strength and rigidity of pressure plate 10.

In all embodiments, backer plate 40 is a rigid vertical planar member with a left edge, a right edge, an upper edge, a lower edge, a front surface, a rear surface, a thickness, a width, a length, and a plane. Backer plate 40 has a width of about 0.2-2 inches, a length of about 2-10 inches, and a thickness of about 0.1-1.0 inches. Backer plate 40 is used to help rigidly mount or rigidly attach pressure plate 10 to a shovel 100.

Pressure plate 10 and backer plate 41 ‘sandwich’ shovel 100 or tightly clamp onto shovel 100 to rigidly attach to shovel 100 so that the plane of pressure plate 10 is perpendicular to the longitudinal axis of the shovel handle 102. Backer plate 40 may be made of any known material such as: metal, steel, aluminum, polymer, plastic, composite, wood, fiberglass, ceramic, carbon fiber, or any other known material. In best mode, backer plate 40 is made of steel.

In all embodiments, there are at least four backer plate mounting holes 42 or a set of four backer plate mounting holes 42 on backer plate 40. There is one backer plate mounting hole 42 for each pressure plate mounting hole 18 wherein a fastener 50 is inserted through each pair of holes to attach foot plate or kick plate that is reversibly attachable to a shovel 5 to a shovel 100. Each backer plate mounting hole 42 must align with a pressure plate mounting hole 18. Each backer plate mounting hole 42 is a circular hole through backer plate 40. Each backer plate mounting hole 42 has a longitudinal axis that is perpendicular to the plane of backer plate 40. Each backer plate mounting hole 42 has an inner diameter that is sized to make a clearance fit with the outer diameter of fastener 50. The backer plate 40 functions as a fastener attachment area that is used to rigidly attach pressure plate 10 to backer plate 40 with a fastener 50.

In all embodiments, each fastener 50 is a bolt, screw, anchor, rivet, or any other known fastener. In the case of a bolt, each fastener 50 includes a nut that is used to attach the fastener. There must be one fastener 50 for each pressure plate mounting hole 18. In best mode, there are four fasteners 50 as depicted.

The first, second, third, and fourth embodiments of foot plate or kick plate that is reversibly attachable to a shovel 5 are reversibly rigidly attached to a shovel 100 as follows. The collar or socket 108 of the shovel blade 104 is placed into the shovel slot 12 on pressure plate 10 so that the rear edge of pressure plate 10 is adjacent to the rear of the shovel 100 and the front edge of pressure plate 10 is adjacent to the front of the shovel 100. Then the backer plate 40 is aligned with the upper mounting flanges 14 and the lower mounting flanges 16 on the pressure plate 10 so that the four backer plate mounting holes 42 on the backer plate 40 align with the four pressure plate mounting holes 18 on the upper and lower mounting flanges 14,16 of the pressure plate 10. Next, one fastener 50 is inserted into each of the four aligned holes and tightened so that the shovel slot 12 bears down on the back of the collar or socket 108 on the shovel blade 104 and actually digs into the surface slightly the collar or socket 108 when the fasteners 50 are tightened. Thus, the fasteners are tightened to the point where the shovel slot 12 is slightly embedded within the outer surface of collar or socket 108 of the shovel blade 104. This process yields superior rigid attachment of foot plate or kick plate that is reversibly attachable to a shovel 5 to a shovel 100. Superior rigid attachment is required to yield a sturdy foot plate or kick plate that is reversibly attachable to a shovel 5 that does not move or go anywhere when the user kicks and pounds the pressure plate 40 with all of his might. It would be undesirable for the use if the foot plate or kick plate that is reversibly attachable to a shovel 5 moved relative to the shovel 100 when the user kicks and pounds the pressure plate 40 with all of his might. The user may sometimes have to do this in order to drive the shovel blade 104 into hard ground such as clay or rocky soil. In order to remove these embodiments of foot plate or kick plate that is reversibly attachable to a shovel 5 from shovel 100, complete the above process in reverse.

In a fifth embodiment, foot plate or kick plate that is reversibly attachable to a shovel 5 comprises: a pressure plate 10; a backer plate 40; a plurality of fasteners 50; a saddle bracket 60; a saddle bracket alignment plate 70; a center support member 80; and an outer support member 90.

In the fifth embodiment of foot plate or kick plate that is reversibly attachable to a shovel 5, pressure plate 10 further comprises: a first pressure plate keyhole 32; a second pressure plate keyhole 34; a third pressure plate keyhole 36; and a fourth pressure plate keyhole 38.

First pressure plate keyhole 32 is a rectangular shaped slot, hole, notch, or slit in pressure plate 10 that has a length and a width that is sized to make a slip fit or clearance fit with a first center support member key 82. First pressure plate keyhole 32 is located adjacent to the front edge of pressure plate 10. First pressure plate keyhole 32 receives first center support member key 82 and functions to help locate and retain center support member 80.

Second pressure plate keyhole 34 is a rectangular shaped slot, hole, notch, or slit in pressure plate 10 that has a length and a width that is sized to make a slip fit or clearance fit with a second center support member key 84. Second pressure plate keyhole 34 is located adjacent to the rear edge of pressure plate 10. Second pressure plate keyhole 34 receives second center support member key 84 and functions to help locate and retain center support member 80.

Third pressure plate keyhole 36 is a rectangular shaped slot, hole, notch, or slit in pressure plate 10 that has a length and a width that is sized to make a slip fit or clearance fit with a first outer support member key 92. Third pressure plate keyhole 36 is located adjacent to the left edge/front edge corner of pressure plate 10. Third pressure plate keyhole 36 receives first outer support member key 92 and functions to help locate and retain outer support member 90.

Fourth pressure plate keyhole 38 is a rectangular shaped slot, hole, notch, or slit in pressure plate 10 that has a length and a width that is sized to make a slip fit or clearance fit with a second outer support member key 94. Fourth pressure plate keyhole 38 is located adjacent to the right edge/front edge corner of pressure plate 10. Fourth pressure plate keyhole 38 receives second outer support member key 94 and functions to help locate and retain outer support member 90 to pressure plate 10.

In the fifth embodiment of foot plate or kick plate that is reversibly attachable to a shovel 5, backer plate 40 further comprises: a backer plate keyhole 44. Backer plate keyhole 44 is a rectangular shaped slot, hole, notch, or slit in backer plate 40 that has a length and a width that is sized to make a slip fit or clearance fit with a saddle bracket alignment plate key 72. Backer plate keyhole 44 is located in the middle or center of backer plate 40. Backer plate keyhole 44 receives saddle bracket alignment plate key 72 and functions to help locate and retain saddle bracket 60.

Saddle bracket 60 is a rigid sheet of material in an arc shape, bow shape, or C shape, as depicted. Saddle bracket 60 has a length, a width, a thickness, a curved side, and an open side. The curved side of saddle bracket 60 is a half-circle shape with an inside diameter that is sized to match the outside diameter of collar or socket 108 on shovel 100. The open side of saddle bracket 60 is open with an inside dimension that is sized to make a slip fit or clearance fit with the outside diameter of collar or socket 108 on shovel 100. Saddle bracket 60 functions to help attach and support center support member 80 and to help attach and support saddle bracket alignment plate 70 as described below. Saddle bracket 60 may be made of any known material such as: metal, steel, aluminum, polymer, plastic, composite, wood, fiberglass, ceramic, carbon fiber, or any other known material. In best mode, Saddle bracket 60 is made of hardened steel.

Saddle bracket 60 has a saddle bracket keyhole 62. Saddle bracket keyhole 62 is a rectangular shaped slot, hole, notch, or slit in saddle bracket 60 that has a length and a width that is sized to make a slip fit or clearance fit with a third center support member key 86. Saddle bracket keyhole 62 is located on the curved side of saddle bracket 60. Saddle bracket keyhole 62 receives third center support member key 86 and functions to help locate and retain center support member 80.

Saddle bracket alignment plate 70 is a rigid horizontal planar member with a front edge, a rear edge, a left edge, a right edge, an upper surface, a lower surface, a thickness, a width, a length, and a plane. The rear edge of saddle bracket alignment plate 70 is radiused or crescent moon shaped. The radius is oriented concave outwards towards the rear or ‘concave rearwards’. The diameter of the radius is sized to match the diameter of a shovel handle 102. The left edge of saddle bracket alignment plate 70 is parallel with the right edge of saddle bracket alignment plate 70.

The front edge of saddle bracket alignment plate 70 has a saddle bracket alignment plate key 72. Saddle bracket alignment plate key 72 is a rigid rectangular or square tab. Saddle bracket alignment plate key 72 has a width, a length, and a thickness that is sized to make a slip fit or clearance fit with backer plate keyhole 44. Saddle bracket alignment plate key 72 is a planar member that is coplanar with the plane of saddle bracket alignment plate 70. Saddle bracket alignment plate key 72 is integral with saddle bracket alignment plate 70 and made from the same piece of material as saddle bracket alignment plate 70.

Saddle bracket alignment plate 70 may be made of any known material such as: metal, steel, aluminum, polymer, plastic, composite, wood, fiberglass, ceramic, carbon fiber, or any other known material. In best mode, saddle bracket alignment plate 70 is made of hardened steel. As stated below, saddle bracket alignment plate 70 must be hard enough to pierce the surface of the collar or socket 108 of shovel blade 104.

Center support member 80 is a rigid vertical rectangular planar member with a front edge, a rear edge, an upper edge, a lower edge, a left surface, a right surface, a thickness, a width, a length, and a plane. The upper edge of center support member 80 is parallel with the lower edge of center support member 80. The upper edge of center support member 80 has a first center support member key 82 and a second center support member key 84. The front edge of center support member 80 has a third center support member key 86. The rear edge of center support member 80 has a fourth center support member key 88. Center support member 80 functions to provide support for the pressure plate 10. Center support member 80 supports pressure plate 10 in the same way that a joist supports a floor. Center support member 80 may be made of any known material such as: metal, steel, aluminum, polymer, plastic, composite, wood, fiberglass, ceramic, carbon fiber, or any other known material. In best mode, center support member 80 is made of hardened steel.

First center support member key 82 is a rigid rectangular or square tab. First center support member key 82 has a width, a length, and a thickness that is sized to make a slip fit or clearance fit with first pressure plate keyhole 32. First center support member key 82 is a planar member that is coplanar with the plane of center support member 80. First center support member key 82 is integral with center support member 80 and made from the same piece of material as center support member 80.

Second center support member key 84 is a rigid rectangular or square tab. Second center support member key 84 has a width, a length, and a thickness that is sized to make a slip fit or clearance fit with second pressure plate keyhole 34. Second center support member key 84 is a planar member that is coplanar with the plane of center support member 80. Second center support member key 84 is integral with center support member 80 and made from the same piece of material as center support member 80.

Third center support member key 86 is a rigid rectangular or square tab. Third center support member key 86 has a width, a length, and a thickness that is sized to make a slip fit or clearance fit with saddle bracket keyhole 62. Third center support member key 88 is a planar member that is coplanar with the plane of center support member 80. Third center support member key 86 is integral with center support member 80 and made from the same piece of material as center support member 80.

Fourth center support member key 88 is a rigid rectangular or square tab. Fourth center support member key 86 has a width, a length, and a thickness that is sized to make a slip fit or clearance fit with an outer support member keyhole 96. Fourth center support member key 88 is a planar member that is coplanar with the plane of center support member 80. Fourth center support member key 88 is integral with center support member 80 and made from the same piece of material as center support member 80.

Outer support member 90 is a rigid U-shaped horizontal planer member. The U shape may be a rounded U-shape, a square U-shape, or a bent U-shape with two bends that form the U shape, as depicted. Outer support member has a left branch, a center branch, and a right branch. Left branch has a front edge, a rear edge, an upper edge, a lower edge, a left surface, a right surface, a thickness, a width, a length, a plane, and a longitudinal axis. Center branch has a front surface, a rear surface, an upper edge, a lower edge, a left edge, a right edge, a thickness, a width, a length, a plane, and a longitudinal axis. Right branch has a front edge, a rear edge, an upper edge, a lower edge, a left surface, a right surface, a thickness, a width, a length, a plane, and a longitudinal axis. The widths of left, center, and right branch are equal, which are also equal to the width of center support member 80. Left branch, center branch, and right branch are connected to form the U-shape. The rear edge of left branch is contiguous with the left edge of center branch. The right edge of center branch is contiguous with the rear edge of right branch. The longitudinal axis of left branch is parallel with that of center branch which is parallel with that of right branch. In best mode, left branch, center branch, and right branch are integral and made form the same piece of material. The upper edge of the left branch has a first outer support member key 92. The upper edge of right branch has a second outer support member key 94. Center branch has an outer support member keyhole 96. Outer support member 90 functions to provide support for the pressure plate 10. Outer support member 90 supports pressure plate 10 in the same way that a joist supports a floor. Outer support member 90 may be made of any known material such as: metal, steel, aluminum, polymer, plastic, composite, wood, fiberglass, ceramic, carbon fiber, or any other known material. In best mode, outer support member 90 is made of hardened steel.

First outer support member key 92 is a rigid rectangular or square tab. First outer support member key 92 has a width, a length, and a thickness that is sized to make a slip fit or clearance fit with third pressure plate keyhole 36. First outer support member key 92 is a planar member that is coplanar with the plane of the left branch of outer support member 90. First outer support member key 92 is integral with the left branch of outer support member 90 and made from the same piece of material.

Second outer support member key 94 is a rigid rectangular or square tab. Second outer support member key 94 has a width, a length, and a thickness that is sized to make a slip fit or clearance fit with fourth pressure plate keyhole 38. Second outer support member key 94 is a planar member that is coplanar with the plane of the right branch of outer support member 90. Second outer support member key 92 is integral with the right branch of outer support member 90 and made from the same piece of material.

Outer support member keyhole 96 is a rectangular shaped slot, hole, notch, or slit in the center branch of outer support member 90 that has a length and a width that is sized to make a slip fit or clearance fit with the fourth center support member key 88. Outer support member keyhole 96 receives fourth center support member key 88 and functions to help locate and retain outer support member 90.

The fifth embodiment of foot plate or kick plate that is reversibly attachable to a shovel 5 is reversibly rigidly attached to a shovel 100 as follows. First, the center support member 80 is attached to pressure plate 10 by simultaneously: inserting first center support member key 82 into first pressure plate keyhole 32 and inserting second center support member key 84 into second pressure plate keyhole 34. Next, the outer support member 80 is attached to the pressure plate 10 by simultaneously: inserting first outer support member key 92 into third pressure plate keyhole 36, inserting second outer support member key 94 into fourth pressure plate keyhole 38, and inserting fourth center support member key 88 into outer support member keyhole 96. Then, the saddle bracket 60 is attached to the assembly by inserting the third center support member key 86 into the saddle bracket keyhole 62 and retaining the saddle bracket 60 in this position. Next, the collar or socket 108 of the shovel blade 104 is placed into the concave area of the saddle bracket 60 and into the shovel slot 12 on pressure plate 10 so that the rear edge of pressure plate 10 is adjacent to the rear of the shovel 100 and the front edge of pressure plate 10 is adjacent to the front of the shovel 100. Then, the saddle bracket alignment plate 70 is attached to the assembly by holding the radiused rear edge of saddle bracket alignment plate 70 adjacent to the front of the collar or socket 108 of the shovel 100. Next, the backer plate 40 is attached to the assembly by placing the backer plate keyhole 44 over the saddle bracket alignment plate key 72 and aligning the four backer plate mounting holes 42 with the four pressure plate mounting holes 18 on the upper mounting flanges 14 and the lower mounting flanges 16 on the pressure plate 10. Then, one fastener 50 is inserted into each of the four aligned holes and tightened so that the radiused rear edge of saddle bracket alignment plate bears down on the front of the collar or socket 108 on the shovel blade 104 and actually digs into the surface slightly the collar or socket 108 when the fasteners 50 are tightened. Thus, the fasteners are tightened to the point where the saddle bracket alignment plate is slightly embedded within the outer surface of collar or socket 108 of the shovel blade 104. This process yields superior rigid attachment of foot plate or kick plate that is reversibly attachable to a shovel 5 to a shovel 100. Superior rigid attachment is required to yield a sturdy foot plate or kick plate that is reversibly attachable to a shovel 5 that does not move or go anywhere when the user kicks and pounds the pressure plate 40 with all of his might. It would be undesirable for the use if the foot plate or kick plate that is reversibly attachable to a shovel 5 moved relative to the shovel 100 when the user kicks and pounds the pressure plate 40 with all of his might. The user may sometimes have to do this in order to drive the shovel blade 104 into hard ground such as clay or rocky soil. In order to remove this embodiment of foot plate or kick plate that is reversibly attachable to a shovel 5 from shovel 100, complete the above process in reverse.

In order to use all embodiments of foot plate or kick plate that is reversibly attachable to a shovel 5, the person 110 using the shovel 100 simply presses down on the upper surface of the pressure plate 10 with his foot 112 as depicted in FIG. 1. The person 110 may also kick downwards on the upper surface of the pressure plate 10 with his foot 112 with all his might. These actions result in exponentially more downward pressure on the shovel blade 104 as compared to the pressure than is applied without the foot plate or kick plate that is reversibly attachable to a shovel 5.

What is claimed is:

1. A foot plate or kick plate that is reversibly attachable to a shovel comprising: a pressure plate; a backer plate; and a plurality of fasteners, wherein,
said pressure plate is a rigid horizontal planar member with a front edge, a rear edge, a left edge, a right edge, an upper surface, a lower surface, a thickness, a width, a length, and a plane;
said front edge of said pressure plate has a shovel slot;
said shovel slot is an aperture, slit, opening, or, notch with a width, a length, a front end, a rear end, and a longitudinal axis;
said front edge of said pressure plate has a set of two upper mounting flanges and a set of two lower mounting flanges;
each of said set of two upper mounting flanges is a protruded ridge, lip, rim, or flange;
each of said set of two upper mounting flanges is a rigid planar member with an upper edge, a lower edge, a left edge, a right edge, a front surface, a rear surface, a width, a length, a thickness, and a plane;
said lower edge of each of said set of two upper mounting flanges is contiguous with said front edge of said pressure plate;
said plane of each of said set of two upper mounting flanges is perpendicular to said plane of said pressure plate;
each of said set of two upper mounting flanges has a pressure plate mounting hole that is a circular hole;
each of said set of two lower mounting flanges is a protruded ridge, lip, rim, or flange;
each of said set of two lower mounting flanges is a rigid planar member with an upper edge, a lower edge, a left edge, a right edge, a front surface, a rear surface, a width, a length, a thickness, and a plane;
said upper edge of each of said set of two lower mounting flanges is contiguous with said front edge of said pressure plate;
said plane of each of said set of two lower mounting flanges is perpendicular to said plane of said pressure plate;
each of said set of two lower mounting flanges has a pressure plate mounting hole that is a circular hole;
said pressure plate has one or more pressure plate beads wherein each of said one or more pressure plate beads is a groove, channel, trough, or depression in said pressure plate that is rolled, pressed, or formed into said plane of said pressure plate;
said backer plate is a rigid vertical planar member with a left edge, a right edge, an upper edge, a lower edge, a front surface, a rear surface, a thickness, a width, a length, and a plane;
said backer plate has at least four backer plate mounting holes that are each a circular hole through said backer plate;
each of said plurality of fasteners is a bolt, screw, anchor, or rivet;
said pressure plate is reversibly rigidly attachable to a shovel wherein said shovel is placed into said shovel slot, said backer plate is aligned with said set of two upper mounting flanges and said set of two lower mounting flanges so that each of said at least four backer plate mounting holes aligns with said pressure plate mounting holes on said set of two upper mounting flanges and said set of two lower mounting flanges; and
one of said plurality of fasteners is inserted into each of said at least four backer plate mounting holes and attached therein.

2. A foot plate or kick plate that is reversibly attachable to a shovel as recited in claim 1, wherein said pressure plate further comprises: a pressure plate left edge flange, a pressure plate right edge flange, and a pressure plate rear edge flange, wherein,
said pressure plate left edge flange is a protruded ridge, lip, rim, or flange;
said pressure plate left edge flange is a rigid planar member with an upper edge, a lower edge, a front edge, a rear edge, a left surface, a right surface, a width, a length, a thickness, and a plane;
said upper edge of said pressure plate left edge flange is contiguous said left edge of said pressure plate;
said plane of said pressure plate left edge flange is perpendicular to said plane of said of pressure plate;
said pressure plate right edge flange is a protruded ridge, lip, rim, or flange;
said pressure plate right edge flange is a rigid planar member with an upper edge, a lower edge, a front edge, a rear edge, a left surface, a right surface, a width, a length, a thickness, and a plane;
said upper edge of said pressure plate right edge flange is contiguous said right edge of said pressure plate;
said plane of said pressure plate right edge flange is perpendicular to said plane of said pressure plate;
said pressure plate rear edge flange is a protruded ridge, lip, rim, or flange;
said pressure plate rear edge flange is a rigid planar member with an upper edge, a lower edge, a front edge, a rear edge, a left surface, a right surface, a width, a length, a thickness, and a plane;
said upper edge of said pressure plate rear edge flange is contiguous said rear edge of said pressure plate; and
said plane of said pressure plate rear edge flange is perpendicular to said plane of said pressure plate.

3. A foot plate or kick plate that is reversibly attachable to a shovel as recited in claim 2, wherein said pressure plate further comprises: a pressure plate left rear edge flange and a pressure plate right rear edge flange, wherein,
said pressure plate left rear edge flange is a protruded ridge, lip, rim, or flange;
said pressure plate left rear edge flange is a rigid planar member with an upper edge, a lower edge, a front edge, a rear edge, a left surface, a right surface, a width, a length, a thickness, and a plane;
said upper edge of said pressure plate left rear edge flange is contiguous with a diagonal edge between said left edge and said rear edge of said pressure plate;
said plane of said pressure plate left rear edge flange is perpendicular to said plane of said of pressure plate;
said pressure plate right rear edge flange is a protruded ridge, lip, rim, or flange;
said pressure plate right rear edge flange is a rigid planar member with an upper edge, a lower edge, a front edge, a rear edge, a left surface, a right surface, a width, a length, a thickness, and a plane;
said upper edge of said pressure plate right rear edge flange is contiguous with a diagonal edge between said rear edge and said right edge of said pressure plate; and
said plane of said pressure plate right rear edge flange is perpendicular to said plane of said pressure plate.

4. A foot plate or kick plate that is reversibly attachable to a shovel comprising: a pressure plate; a backer plate; and a plurality of fasteners; a saddle bracket; a saddle bracket alignment plate; a center support member; and an outer support member, wherein,
said pressure plate is a rigid horizontal planar member with a front edge, a rear edge, a left edge, a right edge, an upper surface, a lower surface, a thickness, a width, a length, and a plane;
said front edge of said pressure plate has a shovel slot;
said shovel slot is an aperture, slit, opening, or, notch with a width, a length, a front end, a rear end, and a longitudinal axis;
said front edge of said pressure plate has a set of two upper mounting flanges and a set of two lower mounting flanges;
each of said set of two upper mounting flanges is a protruded ridge, lip, rim, or flange;
each of said set of two upper mounting flanges is a rigid planar member with an upper edge, a lower edge, a left edge, a right edge, a front surface, a rear surface, a width, a length, a thickness, and a plane;
said lower edge of each of said set of two upper mounting flanges is contiguous with said front edge of said pressure plate;
said plane of each of said set of two upper mounting flanges is perpendicular to said plane of said pressure plate;
each of said set of two upper mounting flanges has a pressure plate mounting hole that is a circular hole;
each of said set of two lower mounting flanges is a protruded ridge, lip, rim, or flange;
each of said set of two lower mounting flanges is a rigid planar member with an upper edge, a lower edge, a left edge, a right edge, a front surface, a rear surface, a width, a length, a thickness, and a plane;
said upper edge of each of said set of two lower mounting flanges is contiguous with said front edge of said pressure plate;
said plane of each of said set of two lower mounting flanges is perpendicular to said plane of said pressure plate;
each of said set of two lower mounting flanges has a pressure plate mounting hole that is a circular hole;
said pressure plate further comprises: a first pressure plate keyhole; a second pressure plate keyhole; a third pressure plate keyhole; and a fourth pressure plate keyhole, wherein,
said first pressure plate keyhole is a rectangular shaped slot, hole, notch, or slit in said pressure plate that has a length and a width that is sized to make a slip fit or clearance fit with a first center support member key;
said first pressure plate keyhole is located adjacent to said front edge of said pressure plate;
said pressure plate keyhole is a rectangular shaped slot, hole, notch, or slit in said pressure plate that has a length and a width that is sized to make a slip fit or clearance fit with a second center support member key;
said second pressure plate keyhole is located adjacent to said rear edge of said pressure plate;
said third pressure plate keyhole is a rectangular shaped slot, hole, notch, or slit in said pressure plate that has a length and a width that is sized to make a slip fit or clearance fit with a first outer support member key,
said third pressure plate keyhole is located adjacent to said left edge and said front edge of said pressure plate;
said fourth pressure plate keyhole is a rectangular shaped slot, hole, notch, or slit in said pressure plate that has a length and a width that is sized to make a slip fit or clearance fit with a second outer support member key;
said fourth pressure plate keyhole is located adjacent to said right edge and said front edge of said pressure plate;
said backer plate is a rigid vertical planar member with a left edge, a right edge, an upper edge, a lower edge, a front surface, a rear surface, a thickness, a width, a length, and a plane;
said backer plate has at least four backer plate mounting holes that are each a circular hole through said backer plate;
said backer plate further comprises a backer plate keyhole that is a rectangular shaped slot, hole, notch, or slit in said backer plate that has a length and a width that is sized to make a slip fit or clearance fit with a saddle bracket alignment plate key;
each of said plurality of fasteners is a bolt, screw, anchor, or rivet;
said saddle bracket is a rigid sheet of material in an arc shape, bow shape, or C shape;
said saddle bracket has a length, a width, a thickness, a curved side, and an open side;
said curved side of said saddle bracket is a half-circle shape with an inside diameter that is sized to match an outside diameter of a collar or socket on a shovel;
said saddle bracket further comprises a saddle bracket keyhole that is a rectangular shaped slot, hole, notch, or slit in saddle bracket that has a length and a width that is sized to make a slip fit or clearance fit with a third center support member key,
said saddle bracket keyhole is located on said curved side of said saddle bracket;
said saddle bracket alignment plate is a rigid horizontal planar member with a front edge, a rear edge, a left edge, a right edge, an upper surface, a lower surface, a thickness, a width, a length, and a plane,
said rear edge of said saddle bracket alignment plate is radiused or crescent moon shaped that is oriented concave outwards towards said rear edge with a diameter that is sized to match said outside diameter of said collar or socket on said shovel;
said saddle bracket alignment plate further comprises a saddle bracket alignment plate key that is a rigid rectangular or square tab with a width, a length, and a thickness that is sized to make a slip fit or clearance fit with said backer plate keyhole;
said center support member is a rigid vertical rectangular planar member with a front edge, a rear edge, an upper edge, a lower edge, a left surface, a right surface, a thickness, a width, a length, and a plane;
said upper edge of said center support member is parallel with said lower edge of said center support member;
said upper edge of center support member has a first center support member key and a second center support member key;
said first center support member key is a rigid rectangular or square tab with a width, a length, and a thickness that is sized to make a slip fit or clearance fit with said first pressure plate keyhole;
said second center support member key is a rigid rectangular or square tab with a width, a length, and a thickness that is sized to make a slip fit or clearance fit with said second pressure plate keyhole;
said front edge of center support member has a third center support member key;
said third center support member key is a rigid rectangular or square tab with a width, a length, and a thickness that is sized to make a slip fit or clearance fit with said saddle bracket keyhole;
said rear edge of center support member has a fourth center support member key;
said fourth center support member key is a rigid rectangular or square tab with a width, a length, and a thickness that is sized to make a slip fit or clearance fit with an outer support member keyhole;
said outer support member is a rigid U-shaped horizontal planer member with a left branch, a center branch, and a right branch;
said left branch has a front edge, a rear edge, an upper edge, a lower edge, a left surface, a right surface, a thickness, a width, a length, a plane, and a longitudinal axis;
said upper edge of said left branch has a first outer support member key that is a rigid rectangular or square tab with a width, a length, and a thickness that is sized to make a slip fit or clearance fit with said third pressure plate keyhole;
said center branch has a front surface, a rear surface, an upper edge, a lower edge, a left edge, a right edge, a thickness, a width, a length, a plane, and a longitudinal axis;
said center branch has an outer support member keyhole that is a rectangular shaped slot, hole, notch, or slit in said center branch that has a length and a width that is sized to make a slip fit or clearance fit with said fourth center support member key;
said right branch has a front edge, a rear edge, an upper edge, a lower edge, a left surface, a right surface, a thickness, a width, a length, a plane, and a longitudinal axis; and
said upper edge of said right branch has a second outer support member key that is a rigid rectangular or square tab with a width, a length, and a thickness that is sized to make a slip fit or clearance fit with said fourth pressure plate keyhole;
said pressure plate is reversibly rigidly attachable to said shovel, wherein,
said center support member is attached to said pressure plate by simultaneously: inserting said first center support member key into said first pressure plate keyhole and inserting said second center support member key into said second pressure plate keyhole,
said outer support member is attached to said pressure plate by simultaneously: inserting said first outer support member key into said third pressure plate keyhole, inserting said second outer support member key into said fourth pressure plate keyhole, and inserting said fourth center support member key into said outer support member keyhole;
said saddle bracket is attached by inserting said third center support member key into said saddle bracket keyhole;
said collar or socket of said shovel is placed into said open side of said saddle bracket and into said shovel slot on said pressure plate;
said saddle bracket alignment plate is attached by holding said rear edge of said saddle bracket alignment plate adjacent to said collar or socket of said shovel;
said backer plate is attached by placing said backer plate keyhole over said saddle bracket alignment plate key and aligning said at least four backer plate mounting holes with said pressure plate mounting holes on said upper mounting flanges and said lower mounting flanges; and
one of said plurality of fasteners is inserted into each of said at least four backer plate mounting holes and attached therein.
